(19) United States
(12) Patent Application Publication
(10) Pub. No.: US 2026/0274613 A1
(43) Pub. Date: Sep. 17, 2026

(54) VERIFICATION OF AN ELEVATOR SYSTEM PART OR SPARE PART

(71) Applicant: KONE Corporation, Helsinki (FI)

(72) Inventors: Mohit Sethi, Helsinki (FI); Mika Katara, Helsinki (FI); Jussi Valkiainen, Helsinki (FI)

(73) Assignee: KONE Corporation, Helsinki (FI)

(21) Appl. No.: 19/666,991

(22) Filed: May 4, 2026

Related U.S. Application Data
(63) Continuation of application No. PCT/EP2023/085383, filed on Dec. 12, 2023.

(51) Int. Cl. B66B 5/00; B66B 1/34

(52) U.S. Cl. CPC B66B 5/0087; B66B 1/3461

(57) ABSTRACT

According to an aspect, there is provided an elevator system apparatus comprising at least one processor and at least one memory storing instructions that, when executed by the at least one processor, cause the elevator system apparatus to at least perform: obtaining a signature associated with the elevator system apparatus, the signature having been generated based at least in part on an elevator system apparatus identifier and metadata at least in part associated with an elevator system part to be installed; obtaining the metadata; and verifying the signature using an encryption key, the elevator system apparatus identifier and the metadata.

### TECHNICAL FIELD

Various examples generally relate to the field of elevator systems. In particular, some examples relate to a solution for enabling a verification of an elevator system part of spare part.

### BACKGROUND

When performing maintenance and upgrades of various components in an elevator system, elevator manufacturers and component manufacturers may want to prevent the usage of counterfeit parts and components. Counterfeit parts, such as ropes, brakes or dampers, can lead to degraded performance, and in the worst case, they may compromise the safety of the elevator system.

Therefore, a solution is needed which would enable for ensuring that original and/or elevator system manufacturer approved components are used when performing maintenance and/or upgrades in the elevator system.

### SUMMARY

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

According to a first aspect, there is provided an elevator system apparatus comprising at least one processor and at least one memory storing instructions that, when executed by the at least one processor, cause the elevator system apparatus to at least perform: obtaining a signature associated with the elevator system apparatus, the signature having been generated based at least in part on an elevator system apparatus identifier and metadata at least in part associated with an elevator system part to be installed; obtaining the metadata; and verifying the signature using an encryption key, the elevator system apparatus identifier and the metadata.

In an implementation form of the first aspect, the at least one memory stores instructions that, when executed by the at least one processor, cause the elevator system apparatus to at least perform: outputting an indication about a successful verification in response to successfully verifying the signature.

In an implementation form of the first aspect, the metadata comprises at least one of the following: an identifier of the elevator system part; a serial number of the elevator system part; an installer identifier of the elevator system part; elevator system apparatus location; customer information; an identifier of a device that was used to order the elevator system part; an identifier of a device involved in installing the elevator system part; a date; and an identifier of a user responsible for the installation.

In an implementation form of the first aspect, the at least one memory stores instructions that, when executed by the at least one processor, cause the elevator system apparatus to at least perform: in response to a successful verification, performing at least one check associated with the elevator system part; and resetting a maintenance tracker associated with an existing elevator system part in response to performing the at least one check, the maintenance tracker tracking the usage of the existing elevator system part.

In an implementation form of the first aspect, the at least one check comprises: checking that the part number of the elevator system part is correct for the elevator system apparatus; and/or checking that a serial number of the elevator system part has not been used earlier.

In an implementation form of the first aspect, obtaining a signature associated with the elevator system apparatus comprises obtaining the signature from a network apparatus that generated the signature.

In an implementation form of the first aspect, obtaining a signature associated with the elevator system apparatus comprises obtaining the signature via a user input from a user.

In an implementation form of the first aspect, obtaining a signature associated with the elevator system apparatus comprises obtaining the signature from a user device via a wireless data transmission.

In an implementation form of the first aspect, obtaining the metadata comprises obtaining the metadata from a network apparatus that generated the signature.

In an implementation form of the first aspect, obtaining the metadata comprises obtaining the metadata from a user device via a wireless data transmission.

In an implementation form of the first aspect, obtaining the metadata comprises obtaining the metadata via a user input from a user.

In an implementation form of the first aspect, the elevator system part comprises a non-digital elevator system component.

In an implementation form of the first aspect, the elevator system part comprises a digital elevator system component.

According to a second aspect, there is provided a network apparatus comprising at least one processor and at least one memory storing instructions that, when executed by the at least one processor, cause the network apparatus to at least perform: obtaining an elevator system apparatus identifier and metadata at least in part associated with an elevator system part to be installed; generating a signature associated with the elevator system apparatus based at least in part on the elevator system apparatus identifier and the metadata; and providing the generated signature and the metadata.

In an implementation form of the second aspect, the at least one memory stores instructions that, when executed by the at least one processor, cause the network apparatus to at least perform: receiving a request for the signature and the metadata; and transmitting the signature and the metadata in response to the request.

In an implementation form of the second aspect, the at least one memory storing instructions that, when executed by the at least one processor, cause the network apparatus to at least perform: transmitting the signature and the metadata to the elevator system apparatus.

In an implementation form of the second aspect, the at least one memory storing instructions that, when executed by the at least one processor, cause the network apparatus to at least perform: receiving a request for the metadata; and transmitting the metadata in response to the request.

In an implementation form of the second aspect, the metadata comprises at least one of the following: an identifier of the elevator system part; a serial number of the elevator system part; an installer identifier of the elevator system part; elevator system apparatus location; customer information; an identifier of a device that was used to order the elevator system part; an identifier of a device involved in installing the elevator system part; a date; and an identifier of a user responsible for the installation.

According to a third aspect, there is provided a method comprising: obtaining, by an elevator system apparatus, a signature associated with the elevator system apparatus, the signature having been generated based at least in part on an elevator system apparatus identifier and metadata at least in part associated with an elevator system part to be installed; obtaining, by the elevator system apparatus, the metadata; and verifying, by the elevator system apparatus, the signature using an encryption key, the elevator system apparatus identifier and the metadata.

In an implementation form of the third aspect, the method further comprises outputting an indication about a successful verification in response to successfully verifying the signature.

In an implementation form of the third aspect, the metadata comprises at least one of the following: an identifier of the elevator system part; a serial number of the elevator system part; an installer identifier of the elevator system part; elevator system apparatus location; customer information; an identifier of a device that was used to order the elevator system part; an identifier of a device involved in installing the elevator system part; a date; and an identifier of a user responsible for the installation.

In an implementation form of the third aspect, the method further comprises: in response to a successful verification, performing at least one check associated with the elevator system part; and resetting a maintenance tracker associated with an existing elevator system part in response to performing the at least one check, the maintenance tracker tracking the usage of the existing elevator system part.

In an implementation form of the third aspect, the at least one check comprises: checking that the part number of the elevator system part is correct for the elevator system apparatus; and/or checking that a serial number of the elevator system part has not been used earlier.

In an implementation form of the third aspect, obtaining a signature associated with the elevator system apparatus comprises obtaining the signature from a network apparatus that generated the signature.

In an implementation form of the third aspect, obtaining a signature associated with the elevator system apparatus comprises obtaining the signature via a user input from a user.

In an implementation form of the third aspect, obtaining a signature associated with the elevator system apparatus comprises obtaining the signature from a user device via a wireless data transmission.

In an implementation form of the third aspect, obtaining the metadata comprises obtaining the metadata from a network apparatus that generated the signature.

In an implementation form of the third aspect, obtaining the metadata comprises obtaining the metadata from a user device via a wireless data transmission.

In an implementation form of the third aspect, obtaining the metadata comprises obtaining the metadata via a user input from a user.

In an implementation form of the third aspect, the elevator system part comprises a non-digital elevator system component.

In an implementation form of the third aspect, the elevator system part comprises a digital elevator system component.

According to a fourth aspect, there is provided a method comprising: obtaining, by a network apparatus, an elevator system apparatus identifier and metadata at least in part associated with an elevator system part to be installed; generating, by the network apparatus, a signature associated with the elevator system apparatus, the signature having being generated based at least in part on the elevator system apparatus identifier and the metadata; and providing, by the network apparatus, the generated signature and the metadata.

In an implementation form of the fourth aspect, the method further comprises: receiving a request for the signature and the metadata; and transmitting the signature and the metadata in response to the request.

In an implementation form of the fourth aspect, the method further comprises transmitting the signature and the metadata to the elevator system apparatus.

In an implementation form of the fourth aspect, the method further comprises receiving a request for the metadata; and transmitting the metadata in response to the request.

In an implementation form of the fourth aspect, the metadata comprises at least one of the following: an identifier of the elevator system part; a serial number of the elevator system part; an installer identifier of the elevator system part; elevator system apparatus location; customer information; an identifier of a device that was used to order the elevator system part; an identifier of a device involved in installing the elevator system part; a date; and an identifier of a user responsible for the installation.

According to a fifth aspect, there is provided a computer program comprising instructions which, when the program is executed by at least one processor, cause a system to perform the method of the third or fourth aspect.

According to a sixth aspect, there is provided a computer-readable medium comprising a computer program comprising instructions which, when the program is executed by at least one processor, cause a system to perform the method of the third or fourth aspect.

According to a seventh aspect, there is provided an elevator system apparatus comprising means for: obtaining a signature associated with the elevator system apparatus, the signature having been generated based at least in part on an elevator system apparatus identifier and metadata at least in part associated with an elevator system part to be installed; obtaining the metadata; and verifying the signature using an encryption key, the elevator system apparatus identifier and the metadata.

According to an eighth aspect, there is provided a network apparatus comprising means for: obtaining an elevator system apparatus identifier and metadata at least in part associated with the elevator system part to be installed; generating a signature associated with the elevator system apparatus based at least in part on the elevator system apparatus identifier and the metadata; and providing the generated signature and the metadata.

### BRIEF DESCRIPTION OF THE DRAWINGS

The accompanying drawings, which are included to provide a further understanding of the invention and constitute a part of this specification, illustrate examples of the invention and together with the description help to explain the principles of the invention. In the drawings:

FIG. 1 illustrates a flow diagram of a method according to an example embodiment.

FIG. 2 illustrates a flow diagram of a method according to an example embodiment.

FIG. 3 illustrates a block diagram of an elevator system apparatus according to an example embodiment.

FIG. 4 illustrates a block diagram of a network apparatus according to an example embodiment.

FIG. 5 illustrates a signaling diagram according to an example embodiment.

FIG. 6 illustrates a signaling diagram according to an example embodiment.

FIG. 7 illustrates a signaling diagram according to an example embodiment.

FIG. 8 illustrates a signaling diagram according to an example embodiment.

### DETAILED DESCRIPTION

Various examples and embodiments discussed below illustrate an authorization solution where an elevator system apparatus, for example, an elevator controller, can validate parts to be installed so that counterfeit or non-original parts may be rejected. Additionally, it may also be possible to ensure that only authorized personnel can perform the installation of the parts.

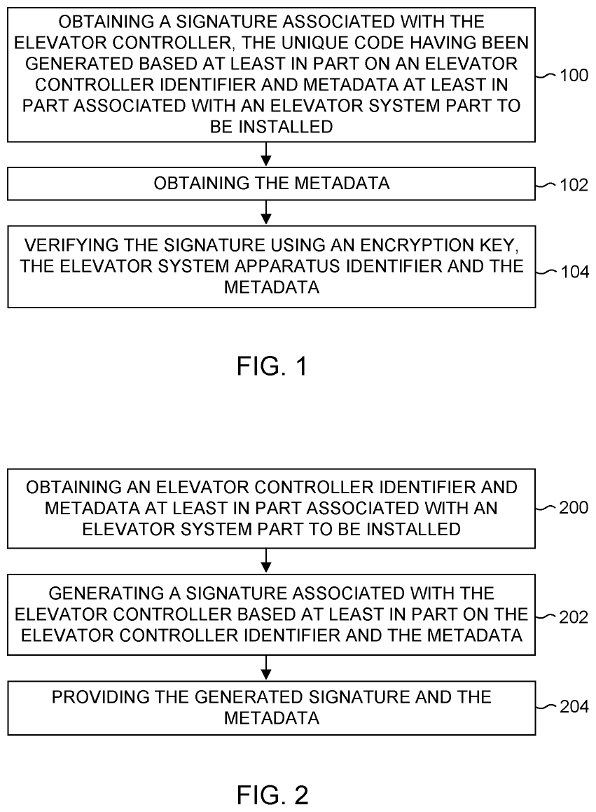

FIG. 1 illustrates a flow diagram of a method according to an example embodiment. The method may be implemented by an elevator system apparatus, for example, an elevator controller.

At 100, a signature associated with the elevator system apparatus may be obtained. The signature may have been generated based at least in part on an elevator controller identifier and metadata at least in part associated with an elevator system part to be installed.

In an example embodiment, the signature associated with the elevator system apparatus may be obtained from a network apparatus that generated the signature via a data communication network. In another example embodiment, the signature associated with the elevator system apparatus may be obtained from a user device via a wireless data transmission. In another example embodiment, the signature associated with the elevator system apparatus may be obtained via a user input from a user.

At 102, the metadata may be obtained. The metadata may comprise, for example, one or more of the following: an identifier of the elevator system part, a serial number of the elevator system part, an installer identifier of the elevator system part, elevator system apparatus location, customer information, an identifier of a device that was used to order the elevator system part, an identifier of a device involved in installing the elevator system part, a date and an identifier of a user responsible for the installation. In an example embodiment, the metadata may be obtained from the network apparatus that generated the signature via a data communication network. In another example embodiment, the metadata may be obtained from a user device via a wireless data transmission. In another example embodiment, the metadata may be obtained via a user input from a user.

At 104, the signature may be verified using an encryption key, the elevator system apparatus identifier and the metadata. In an example embodiment, encryption key may be associated with the elevator system apparatus. As a result of the verification, the signature may be accepted or rejected. In an example embodiment, an indication about a successful verification may be output in response to successfully verifying the signature. The indication may be, for example, a simple led light blinking green.

Alternatively, if the verification is not successful, information indicating this may be provided.

In an example embodiment, in response to a successful verification, at least one check associated with the elevator system part may be performed. A maintenance tracker associated with an existing elevator system part may be reset in response to performing the at least one check, the maintenance tracker tracking the usage of the existing elevator system part. In an example embodiment, the at least one check may include checking, for example, if the part number is correct for the elevator system apparatus and/or that the serial number of the part is not the one which was previously used. If all the additional checks are successful, the elevator system apparatus may reset the maintenance tracker, for example, a counter and/or a timer, tracking the usage of the existing elevator system part.

FIG. 2 illustrates a flow diagram of a method according to an example embodiment. The method may be implemented by a network apparatus, for example, a cloud based server or other device providing an online portal.

At 200, a an elevator system apparatus identifier and metadata at least in part associated with an elevator system part to be installed.

At 202, a signature associated with the elevator system apparatus may be generated based at least in part on the elevator system apparatus identifier and the metadata.

In an example embodiment, the metadata comprises at least one of the following: an identifier of the elevator system part; a serial number of the elevator system part; an installer identifier of the elevator system part; elevator system apparatus location; customer information; an identifier of a device that was used to order the elevator system part; an identifier of a device involved in installing the elevator system part; a date; and an identifier of a user responsible for the installation.

At 204, the generated signature and the metadata may be provided.

In an example embodiment, the signature and the metadata may be transmitted to the elevator system apparatus.

In an example embodiment, a request may be received from a user device for the signature and the metadata, and the signature and the metadata may be transmitted to the user device in response to the request.

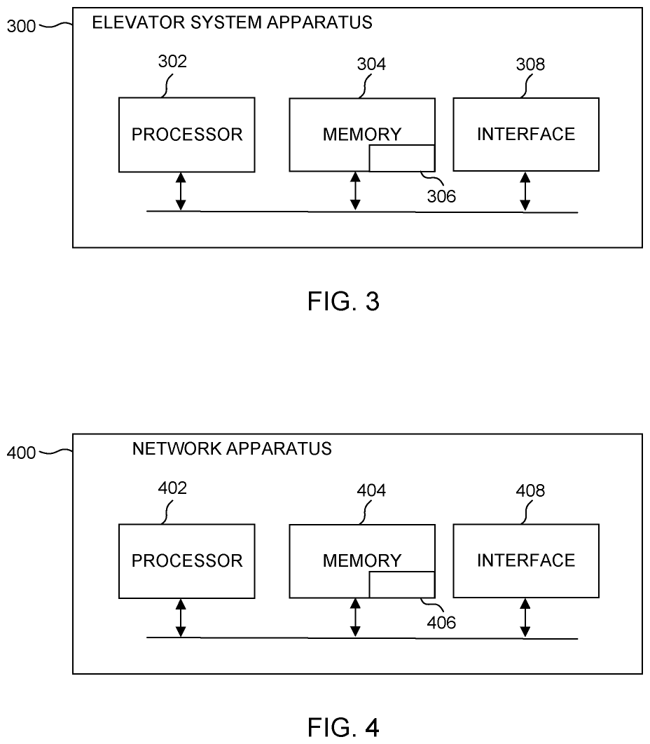

FIG. 3 illustrates a block diagram of an elevator system apparatus 300 according to an example solution. The elevator system apparatus 300 may comprise, for example, an elevator controller or elevator group controller functionality.

The elevator system apparatus 300 comprises one or more processors 302, and one or more memories 304 that comprise computer program code 306, and/or a communication interface 308 for wired and/or wireless communication. Although the elevator system apparatus 300 is depicted to include only one processor 302, the elevator system apparatus 300 may include more than one processor. In an example embodiment, the memory 304 is capable of storing instructions, such as an operating system and/or various applications.

Furthermore, the processor 302 is capable of executing the stored instructions. In an example embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 302 may be configured to execute hard-coded functionality. In an example embodiment, the processor 302 may be embodied as an executor of software instructions, wherein the instructions may specifically configure the processor 302 to perform the algorithms and/or operations described herein when the instructions are executed, for example, the steps discussed relating to any of FIG. 1.

The memory 304 may be embodied as one or more volatile memory devices, one or more non-volatile memory devices, and/or a combination of one or more volatile memory devices and non-volatile memory devices. For example, the memory 304 may be embodied as semiconductor memories (such as mask ROM, PROM (programmable ROM), EPROM (erasable PROM), flash ROM, RAM (random access memory), etc.).

The at least one memory 304 may store program instructions that, when executed by the at least one processor 302, cause the elevator system apparatus 300 to perform the functionality of the various embodiments discussed herein. Further, in an embodiment, at least one of the processor 302 and the memory 304 may constitute means for implementing the discussed functionality. For example, the elevator system apparatus 300 may be configured to obtain a signature associated with the elevator system apparatus, the signature having been generated based at least in part on an elevator system apparatus identifier and metadata at least in part associated with an elevator system part to be installed; obtain the metadata; and verify the signature using an encryption key, the elevator system apparatus identifier and the metadata. A computer program may comprise instructions which, when the program is executed by the at least one processor 302, cause the elevator system apparatus 300 to perform any of the methods described above. Furthermore, a computer-readable medium may comprise the computer program.

FIG. 4 illustrates a block diagram of a network apparatus 400 according to an example solution. The network apparatus 400 may comprise, for example, a network server.

The network apparatus 400 comprises one or more processors 402, and one or more memories 404 that comprise computer program code 406, and/or a communication interface 408 for wired and/or wireless communication. Although the network apparatus 400 is depicted to include only one processor 402, the network apparatus 400 may include more than one processor. In an example embodiment, the memory 404 is capable of storing instructions, such as an operating system and/or various applications.

Furthermore, the processor 402 is capable of executing the stored instructions. In an example embodiment, the processor 402 may be embodied as a multi-core processor, a single core processor, or a combination of one or more multi-core processors and one or more single core processors. For example, the processor 402 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 402 may be configured to execute hard-coded functionality. In an example embodiment, the processor 402 may be embodied as an executor of software instructions, wherein the instructions may specifically configure the processor 402 to perform the algorithms and/or operations described herein when the instructions are executed, for example, the steps discussed relating to FIG. 2.

The memory 404 may be embodied as one or more volatile memory devices, one or more non-volatile memory devices, and/or a combination of one or more volatile memory devices and non-volatile memory devices. For example, the memory 404 may be embodied as semiconductor memories (such as mask ROM, PROM (programmable ROM), EPROM (erasable PROM), flash ROM, RAM (random access memory), etc.).

The at least one memory 404 may store program instructions that, when executed by the at least one processor 402, cause the network apparatus 400 to perform the functionality of the various embodiments discussed herein. Further, in an embodiment, at least one of the processor 402 and the memory 404 may constitute means for implementing the discussed functionality. For example, the network apparatus 400 may be configured to obtain an elevator system apparatus identifier and metadata at least in part associated with an elevator system part to be installed; generate a signature associated with the elevator system apparatus, the signature having being generated based at least in part on the elevator system apparatus identifier and the metadata; and provide the generated signature and the metadata. A computer program may comprise instructions which, when the program is executed by the at least one processor 402, cause the network apparatus 400 to perform any of the methods described above. Furthermore, a computer-readable medium may comprise the computer program.

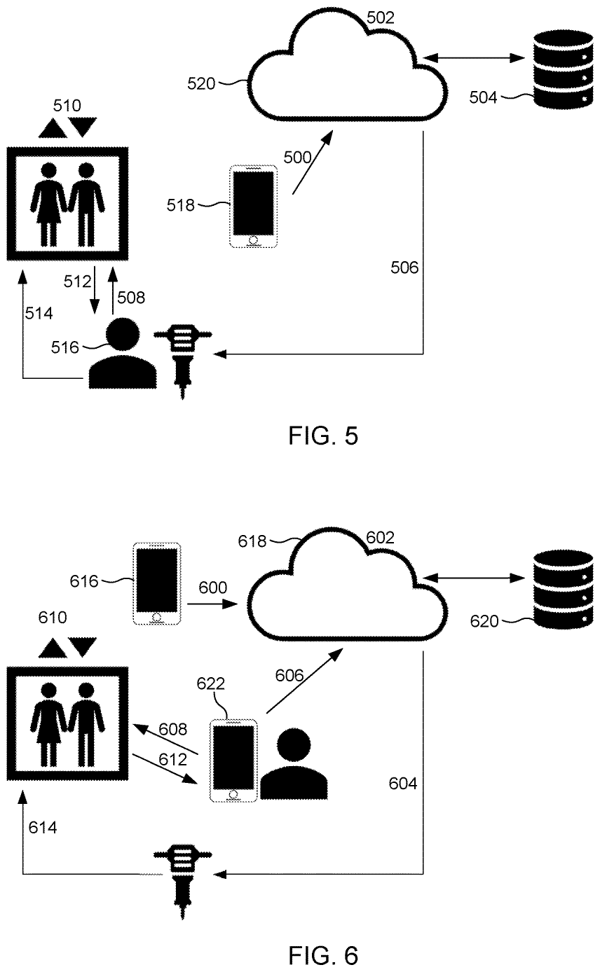

FIG. 5 illustrates a signaling diagram according to an example embodiment. The signaling diagram illustrates a solution for validating an elevator system part to be installed. Although the example discussed below may assume that the part or spare part comprises a non-digital elevator system component, in other embodiments, the part or spare part may comprise a digital elevator system component.

At 500, a device 518, for example, a mobile device, a tablet computer or a computer, may be used by a technician, installer, customer or user to order a part or spare part from an online portal 520 provided by a network device. The part or spare part may be found using, for example, a part identifier or browsing a database. The order may be completed once the correct part or spare part has been found. During the ordering process, the device 518 may be configured to transmit to the online portal 520 an elevator system apparatus identifier for which the part is ordered. A single order may include several parts or spare parts. In an example embodiment, the online portal 520 may receive from the device 518 some additional information associated with the order, for example, one or more of the following: an installer identifier of the elevator system part; elevator system apparatus location; customer information; an identifier of a device that was used to order the elevator system part; an identifier of a device involved in installing the elevator system part, a date, and an identifier of a user responsible for the installation.

At 502, during the ordering process, the online portal 520 may consult databases 504 of factories and/or and suppliers for information about the part or spare part availability before deciding from where the part or spare part will be shipped. When the part or spare part to be shipped has been identified, the online portal 520 may generate a signature. In this example embodiment, the signature will accompany the part or spare part when delivered to a maintenance personnel, technician, installer, customer or user. In an example embodiment, the signature accompanying the part or spare part can be generated, for example, using asymmetric signature schemes such as Elliptic curve digital signature algorithm (ECDSA). The online portal 520 may have a single private key for computing the signature, and the elevator system apparatus may have a public key for verifying the signature. For the example, the signature may be generated as follows:

$$Signature = Sign ( elevator system apparatus identifier , part\_identifier )$$

$$Metadata = part\_identifier$$

In an example embodiment, if a unique serial number for the part or spare part is available, it can be included in the signature generation. In another example embodiment, the unique serial number can also be generated and assigned by the online portal when the part or spare part is being prepared for shipment. Thus, the signature accompanying the part of spare part can also be bound to the unique serial number of the part or spare part delivered:

$$Signature = Sign ( elevator system apparatus identifier , part\_identifier , part\_serial )$$

$$Metadata = part\_identifier , part\_serial$$

When using ECDSA, the signature itself is 64 bytes. In order to verify the signature, the original message contents used to generate the signature are needed. Due to this, the signature may be accompanied with the metadata used to generate the signature. For example, the part_identifier and part_serial of the part or spare part being installed may be provided to the elevator system apparatus along with the signature.

In an example embodiment, some implementations of message signing are such that the signature generated by a signing function already includes all the plaintext data that was signed. This means that only the output of the signing needs to be encoded and sent to the elevator system apparatus. However, in another example embodiment, it is also possible to detach the plaintext data from the signature and send it separately to the elevator system apparatus for verification. This can allow optimization such as compression of the metadata to make it as short as possible or omitting some parts of the metadata if those parts are known by the elevator system apparatus, such as the date.

In an example embodiment, in order to reduce the total amount of data sent to the elevator system apparatus, the generated signature may use short cryptographic signature schemes such as the Boneh-Lynn-Shacham (BLS) signatures. Alternatively, the online portal may generate the signature with a signature scheme such as ISO/IEC 9796-2 which supports full message recovery.

This ensures that only the generated signature needs to be sent to the elevator system apparatus.

In an example embodiment, the signature may additionally be bound to one or more additional pieces of information, for example one or more of the following: an installer identifier of the elevator system part, elevator system apparatus location, customer information, an identifier of a device that was used to order the elevator system part, an identifier of a device involved in installing the elevator system part, a date and a user responsible for the installation. For example, the following binds the signature to the identifier of the person who will be responsible for installing the part or spare part:

$$Signature = Sign ( elevator system apparatus identifer , part\_identifier , part\_serial , installer\_identifier , date )$$

$$Metadata = part\_identifier , part\_serial , installer\_identifier , date$$

The metadata can be used to ensure that the correct spare part is being delivered and installed. It can be used to enforce customer requirements, such as not allowing to replace a silver panel with a white one.

Further, to comply with the export regulations, elevator system apparatus may refuse the signature generated for another location.

In an example embodiment, if the online portal 520 and the elevator system apparatus share a password or a symmetric key, a hash-based message authentication (HMAC) or similar cryptographic construction may be used for generating the signature accompanying the part or spare part.

In an example embodiment, an elevator system apparatus manufacturer owning the keys used to generate the code and verifying it in the elevator system apparatus can use other parties such as OEMs (Original Equipment Manufacturer) for the manufacturing, warehousing, and parts deliveries. The party owning the keys can also outsource or license the whole or some parts of the process. In such a case, the signature generation may involve a front-end that relays signature generation requests to a backend. The elevator system apparatus manufacturer owning the keys can generate the signature in the backend and send the signature to the front-end that then delivers the signature the party which ordered the signature.

At 506, the part or spare part may delivered to the user, maintenance personnel or technician. In this embodiment, the signature confirming the genuineness of the part or spare part to the elevator system apparatus is sent along with the part or spare part. The signature may be printed on the part or spare part itself or on its packaging. Alternatively, the signature may be delivered in a separate mail package if the signature is generated at a different location than the part or spare part.

At 508, before installing the new part or spare part, the user, maintenance personnel or technician may input the signature accompanying the part or spare part to the elevator system apparatus. The input may be done, for example, manually by typing in the signature and any metadata needed for verifying the signature. For example, a 10-character serial number along with the 160-bit BLS signature encoded in hexadecimal may be of the following form:
CN D1 41 04 FD-56 CB 78 D1 D0 D0 25 76 D6 B3 16 14 3E DD 80 9E 82 B0 A4 24

Binding the signature to more information (i.e., to the metadata) such as the user identifier who made the order will not increase the size of the signature but may increase the amount of data to entered manually as the elevator system apparatus needs all the information not known to it before it can verify the signature. In such cases, the signature be provided to the elevator system apparatus by showing a QR code, a NFC Data Exchange Format (NDEF) tag, via short-range wireless data transmission or via other location limited out-of-band channels such as audio.

At 510, when the elevator system apparatus receives the signature along with the metadata, the elevator system apparatus may verify the signature using the corresponding public key (or symmetric key if HMACs are used). In an example embodiment, if the signature verification is successful, the elevator system apparatus may proceed to perform one or more additional checks. The additional check may include, for example, a check that the part_serial is correct for the elevator system apparatus and/or a check that the part serial is not the one which was previously used. If all the additional checks are successful, the elevator system apparatus may reset any counter or timer tracking the usage of the old part.

At 512, the elevator system apparatus may indicate a successful verification of the signature and all checks (if any checks were made) before the part or spare part installation begins. The indication may be, for example, a simple led light blinking green. In an example embodiment, the elevator system apparatus may also enter a special maintenance mode before the part can be installed.

At 514, the user, maintenance personnel or technician 516 may install the part or spare part. In an example embodiment, it may be possible that the user, maintenance personnel or technician 516 may install the part or spare part before inputting the signature and verifying that the is accepted by the elevator system apparatus.

FIG. 6 illustrates a signaling diagram according to an example embodiment. The signaling diagram illustrates a solution for validating an elevator system part to be installed. Although the example discussed below may assume that the part or spare part comprises a non-digital elevator system component, in other embodiments, the part or spare part may comprise a digital elevator system component.

At 600, a device 616, for example, a mobile device, a tablet computer or a computer, may be used by a technician, installer, customer or user to order a part or spare part from an online portal 618 provided by a network device. The part or spare part may be found using, for example, a part identifier or browsing a database. The order may be completed once the correct part or spare part has been found. During the ordering process, the device 616 may be configured to transmit to the online portal 618 an elevator system apparatus identifier for which the part is ordered. A single order may include several parts or spare parts. In an example embodiment, the online portal 618 may receive from the device 616 additional information associated with the order, for example, one or more of the following: an installer identifier of the elevator system part; elevator system apparatus location; customer information; an identifier of a device that was used to order the elevator system part; an identifier of a device involved in installing the elevator system part, a date, and an identifier of a user responsible for the installation.

At 602, during the ordering process, the online portal 618 may consult databases 620 of factories and/or and suppliers for information about the part or spare part availability before deciding from where the part or spare part will be shipped. When the part or spare part to be shipped has been identified, the online portal 618 may generate a signature. In this embodiment, the signature will accompany the part or spare part when delivered to a maintenance personnel, technician, installer, customer or user. In an example embodiment, the signature accompanying the part or spare part can be generated, for example, using asymmetric signature schemes such as Elliptic curve digital signature algorithm (ECDSA). The online portal 618 may have a single private key for computing the signature, and the elevator system apparatus may have a public key for verifying the signature. For the example, the signature may be generated as follows:

$$Signature = Sign ( elevator system apparatus identifier , part\_identifier )$$

$$Metadata = part \_identifier$$

In an example embodiment, if a unique serial number for the part or spare part is available, it can be included in the signature generation. In another example embodiment, the unique serial number can also be generated and assigned by the online portal when the part or spare part is being prepared for shipment. Thus, the signature accompanying the part of spare part can also be bound to the unique serial number of the part or spare part delivered:

$$Signature = Sign ( elevator system apparatus identifier , part\_identifier , part\_serial )$$

$$Metadata = part \_identifier , part\_serial$$

When using ECDSA, the signature itself is 64 bytes. In order to verify the signature, the original message contents used to generate the signature are needed. Due to this, the signature may be accompanied with the metadata used to generate the signature. For example, the part_identifier and part_serial of the part or spare part being installed may be provided to the elevator system apparatus along with the signature.

In an example embodiment, some implementations of message signing are such that the signature generated by a signing function already includes all the plaintext data that was signed. This means that only the output of the signing needs to be encoded and sent to the elevator system apparatus. However, in another example embodiment, it is also possible to detach the plaintext data from the signature and send it separately to the elevator system apparatus for verification. This can allow optimization such as compression of the metadata to make it as short as possible or omitting some parts of the metadata if those parts are known by the elevator system apparatus, such as the date.

In an example embodiment, in order to reduce the total amount of data sent to the elevator system apparatus, the generated signature may use short cryptographic signature schemes such as the Boneh-Lynn-Shacham (BLS) signatures. Alternatively, the online portal may generate the signature with a signature scheme such as ISO/IEC 9796-2 which supports full message recovery.

This ensures that only the generated signature needs to be sent to the elevator system apparatus.

In an example embodiment, the signature may additionally be bound to one or more additional pieces of information, for example one or more of the following: an installer identifier of the elevator system part, elevator system apparatus location, customer information, an identifier of a device that was used to order the elevator system part, an identifier of a device involved in installing the elevator system part, a date and a user responsible for the installation. For example, the following binds the signature to the identifier of the person who will be responsible for installing the part or spare part:

$$Signature = Sign ( elevator system apparatus identifier , part\_identifier , part\_serial , installer\_identifier , date )$$

$$Metadata = part\_identifier , part\_serial , installer\_identifier , date$$

The metadata can be used to ensure that the correct spare part is being delivered and installed. It can be used to enforce customer requirements, such as not allowing to replace a silver panel with a white one.

Further, to comply with the export regulations, elevator system apparatus may refuse the signature generated for another location.

In an example embodiment, if the online portal 618 and the elevator system apparatus share a password or a symmetric key, a hash-based message authentication (HMAC) or similar cryptographic construction may be used for generating the signature accompanying the part or spare part.

In an example embodiment, an elevator system apparatus manufacturer owning the keys used to generate the code and verifying it in the elevator system apparatus can use other parties such as OEMs (Original Equipment Manufacturer) for the manufacturing, warehousing, and parts deliveries. The party owning the keys can also outsource or license the whole or some parts of the process. In such a case, the signature generation may involve a front-end that relays signature generation requests to a backend. The elevator system apparatus manufacturer owning the keys can generate the signature in the backend and send the signature to the front-end that then delivers the signature the party which ordered the signature.

At 604, the part or spare part may delivered to the user, maintenance personnel or technician.

At 606, the user, maintenance personnel or technician may use a tool 622 such as a service tool for the elevator system apparatus, to obtain the signature (and the metadata needed for verification if it is not part of the signature) from the online portal 618 for the part or service part to be installed. This may be done at the site where the elevator system apparatus is located or before if there is no connectivity to the online portal 618 at the elevator system apparatus location. In an example embodiment, the user, maintenance personnel or technician may also obtain a license for accessing the elevator system apparatus along with the process of obtaining the signature. In an example embodiment, the process of generating the signature may be performed only at this stage instead of at step 602. The benefit of generating the signature at a later stage is that the elevator system apparatus does not need to perform any cryptographic operations before the part or spare part has been delivered.

At 608, the user, maintenance personnel or technician may use the tool 622 on which the signature (and metadata) has been downloaded for sending the signature and the metadata to the elevator system apparatus. In an example embodiment, this may be performed after sending a license that authorizes the user, maintenance personnel or technician to perform the installation of the part or spare part.

At 610, when the elevator system apparatus receives the signature along with the metadata, the elevator system apparatus may verify the signature using the corresponding public key (or symmetric key if HMACs are used). In an example embodiment, if the signature verification is successful, the elevator system apparatus may proceed to perform one or more additional checks. The additional check may include, for example, a check that the part_serial is correct for the elevator system apparatus and/or a check that the part serial is not the one which was previously used. If all the additional checks are successful, the elevator system apparatus may reset any counter or timer tracking the usage of the old part. In an example embodiment, the elevator system apparatus may perform at least one check such as if the user, maintenance personnel or technician and the tool being used are authorized for performing the installation of the part or spare part.

At 612, the elevator system apparatus may indicate a successful verification of the signature and all checks (if any checks were made) before the part or spare part installation begins. The indication may be, for example, a simple led light blinking green. In an example embodiment, the elevator system apparatus may also enter a special maintenance mode before the part can be installed.

At 614, the user, maintenance personnel or technician may install the part or spare part. In an example embodiment, it may be possible that the user, maintenance personnel or technician may install the part or spare part before inputting the signature and verifying that the is accepted by the elevator system apparatus.

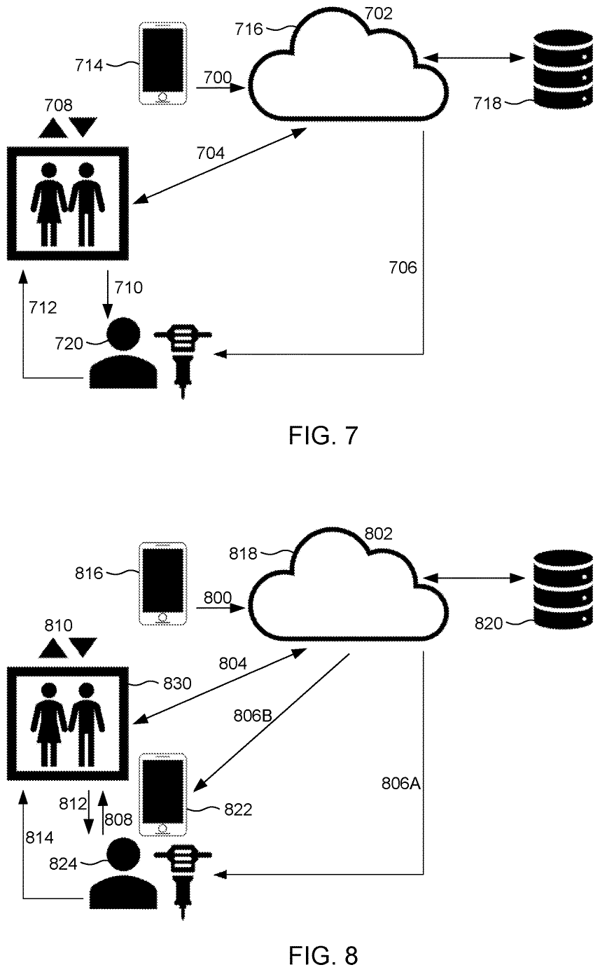

FIG. 7 illustrates a signaling diagram according to an example embodiment. The signaling diagram illustrates a solution for validating an elevator system part to be installed. Although the example discussed below may assume that the part or spare part comprises a non-digital elevator system component, in other embodiments, the part or spare part may comprise a digital elevator system component.

At 700, a device 714, for example, a mobile device, a tablet computer or a computer, may be used by a technician, installer, customer or user to order a part or spare part from an online portal 716 provided by a network device. The part or spare part may be found using, for example, a part identifier or browsing a database. The order may be completed once the correct part or spare part has been found. During the ordering process, the device 714 may be configured to transmit to the online portal 716 an elevator system apparatus identifier for which the part is ordered. A single order may include several parts or spare parts. In an example embodiment, the online portal 716 may receive from the device 714 additional information associated with the order, for example, one or more of the following: an installer identifier of the elevator system part; elevator system apparatus location; customer information; an identifier of a device that was used to order the elevator system part; an identifier of a device involved in installing the elevator system part, a date, and an identifier of a user responsible for the installation.

At 702, during the ordering process, the online portal 716 may consult databases 718 of factories and/or and suppliers for information about the part or spare part availability before deciding from where the part or spare part will be shipped. When the part or spare part to be shipped has been identified, the online portal 716 may generate a signature. In this embodiment, the signature will accompany the part or spare part when delivered to a maintenance personnel, technician, installer, customer or user. In an example embodiment, the signature accompanying the part or spare part can be generated, for example, using asymmetric signature schemes such as Elliptic curve digital signature algorithm (ECDSA). The online portal 716 may have a single private key for computing the signature, and the elevator system apparatus may have a public key for verifying the signature. For the example, the signature may be generated as follows:

$$Signature = Sign ( elevator system apparatus identifier , part\_identifier )$$

$$Metadata = part \_identifier$$

In an example embodiment, if a unique serial number for the part or spare part is available, it can be included in the signature generation. In another example embodiment, the unique serial number can also be generated and assigned by the online portal when the part or spare part is being prepared for shipment. Thus, the signature accompanying the part of spare part can also be bound to the unique serial number of the part or spare part delivered:

$$Signature = Sign ( elevator system apparatus identifier , part\_identifier , part\_serial )$$

$$Metadata = part \_identifier , part\_serial$$

When using ECDSA, the signature itself is 64 bytes. In order to verify the signature, the original message contents used to generate the signature are needed. Due to this, the signature may be accompanied with the metadata used to generate the signature. For example, the part identifier and part serial of the part or spare part being installed may be provided to the elevator system apparatus along with the signature.

In an example embodiment, some implementations of message signing are such that the signature generated by a signing function already includes all the plaintext data that was signed. This means that only the output of the signing needs to be encoded and sent to the elevator system apparatus. However, in another example embodiment, it is also possible to detach the plaintext data from the signature and send it separately to the elevator system apparatus for verification. This can allow optimization such as compression of the metadata to make it as short as possible or omitting some parts of the metadata if those parts are known by the elevator system apparatus, such as the date.

In an example embodiment, in order to reduce the total amount of data sent to the elevator system apparatus, the generated signature may use short cryptographic signature schemes such as the Boneh-Lynn-Shacham (BLS) signatures. Alternatively, the online portal may generate the signature with a signature scheme such as ISO/IEC 9796-2 which supports full message recovery.

This ensures that only the generated signature needs to be sent to the elevator system apparatus.

In an example embodiment, the signature may additionally be bound to one or more additional pieces of information, for example one or more of the following: an installer identifier of the elevator system part, elevator system apparatus location, customer information, an identifier of a device that was used to order the elevator system part, an identifier of a device involved in installing the elevator system part, a date and a user responsible for the installation. For example, the following binds the signature to the identifier of the person who will be responsible for installing the part or spare part:

$$Signature = Sign ( elevator system apparatus identifer , part\_identifier , part\_serial , installer\_identifier , date )$$

$$Metadata = part\_identifier , part\_serial , installer\_identifier , date$$

The metadata can be used to ensure that the correct spare part is being delivered and installed. It can be used to enforce customer requirements, such as not allowing to replace a silver panel with a white one.

Further, to comply with the export regulations, elevator system apparatus may refuse the signature generated for another location.

In an example embodiment, if the online portal 716 and the elevator system apparatus share a password or a symmetric key, a hash-based message authentication (HMAC) or similar cryptographic construction may be used for generating the signature accompanying the part or spare part.

In an example embodiment, an elevator system apparatus manufacturer owning the keys used to generate the code and verifying it in the elevator system apparatus can use other parties such as OEMs (Original Equipment Manufacturer) for the manufacturing, warehousing, and parts deliveries. The party owning the keys can also outsource or license the whole or some parts of the process. In such a case, the signature generation may involve a front-end that relays signature generation requests to a backend. The elevator system apparatus manufacturer owning the keys can generate the signature in the backend and send the signature to the front-end that then delivers the signature the party which ordered the signature.

At 704, the signature and the metadata used in the signature generation may be delivered to the elevator system apparatus from the online portal 716 via data communication. This communication may be protected, for example, with Transport Layer Security (TLS). In an example embodiment, the online portal 716 may also inform the elevator system apparatus about the expected delivery date of the part or spare part.

At 706, the part or spare part is delivered.

At 708, the elevator system apparatus may verify the signature using the corresponding public key (or symmetric key if HMACs are used) and the metadata. In an example embodiment, if the signature verification is successful, the elevator system apparatus may proceed to perform one or more additional checks. The additional check may include, for example, a check that the part_serial is correct for the elevator system apparatus and/or a check that the part_serial is not the one which was previously used. If all the additional checks are successful, the elevator system apparatus may reset any counter or timer tracking the usage of the old part.

At 710, the elevator system apparatus may indicate a successful verification of the signature and all checks (if any checks were made) before the part or spare part installation begins. The indication may be, for example, a simple led light blinking green. In an example embodiment, the elevator system apparatus may also enter a special maintenance mode before the part can be installed.

At 712, the maintenance personnel, technician, installer, customer or user 720 may install the part or spare part. In an example embodiment, the maintenance personnel, technician, installer, customer or user 720 may put the elevator system apparatus in maintenance mode before installing the part or spare part.

FIG. 8 illustrates a signaling diagram according to an example embodiment. The signaling diagram illustrates a solution for validating an elevator system part to be installed. Although the example discussed below may assume that the part or spare part comprises a non-digital elevator system component, in other embodiments, the part or spare part may comprise a digital elevator system component.

At 800, a device 816, for example, a mobile device, a tablet computer or a computer, may be used by a technician, installer, customer or user to order a part or spare part from an online portal 818 provided by a network device. The part or spare part may be found using, for example, a part identifier or browsing a database. The order may be completed once the correct part or spare part has been found. During the ordering process, the device 816 may be configured to transmit to the online portal 818 an elevator system apparatus identifier for which the part is ordered. A single order may include several parts or spare parts. In an example embodiment, the online portal 818 may receive from the device 816 additional information associated with the order, for example, one or more of the following: an installer identifier of the elevator system part; elevator system apparatus location; customer information; an identifier of a device that was used to order the elevator system part; an identifier of a device involved in installing the elevator system part, a date, and an identifier of a user responsible for the installation.

At 802, during the ordering process, the online portal 818 may consult databases 820 of factories and/or and suppliers for information about the part or spare part availability before deciding from where the part or spare part will be shipped. When the part or spare part to be shipped has been identified, the online portal 818 may generate a signature. In this embodiment, the signature will accompany the part or spare part when delivered to a maintenance personnel, technician, installer, customer or user. In an example embodiment, the signature accompanying the part or spare part can be generated, for example, using asymmetric signature schemes such as Elliptic curve digital signature algorithm (ECDSA). The online portal 818 may have a single private key for computing the signature, and the elevator system apparatus may have a public key for verifying the signature. For the example, the signature may be generated as follows:

$$Signature = Sign ( elevator system apparatus identifier , part\_identifier )$$

$$Metadata = part \_identifier$$

In an example embodiment, if a unique serial number for the part or spare part is available, it can be included in the signature generation. In another example embodiment, the unique serial number can also be generated and assigned by the online portal when the part or spare part is being prepared for shipment. Thus, the signature accompanying the part of spare part can also be bound to the unique serial number of the part or spare part delivered:

$$Signature = Sign ( elevator system apparatus identifier , part\_identifier , part\_serial )$$

$$Metadata = part\_identifier , part\_serial$$

When using ECDSA, the signature itself is 64 bytes. In order to verify the signature, the original message contents used to generate the signature are needed. Due to this, the signature may be accompanied with the metadata used to generate the signature. For example, the part_identifier and part_serial of the part or spare part being installed may be provided to the elevator system apparatus along with the signature.

In an example embodiment, some implementations of message signing are such that the signature generated by a signing function already includes all the plaintext data that was signed. This means that only the output of the signing needs to be encoded and sent to the elevator system apparatus. However, in another example embodiment, it is also possible to detach the plaintext data from the signature and send it separately to the elevator system apparatus for verification. This can allow optimization such as compression of the metadata to make it as short as possible or omitting some parts of the metadata if those parts are known by the elevator system apparatus, such as the date.

In an example embodiment, in order to reduce the total amount of data sent to the elevator system apparatus, the generated signature may use short cryptographic signature schemes such as the Boneh-Lynn-Shacham (BLS) signatures. Alternatively, the online portal may generate the signature with a signature scheme such as ISO/IEC 9796-2 which supports full message recovery. This ensures that only the generated signature needs to be sent to the elevator system apparatus.

In an example embodiment, the signature may additionally be bound to one or more additional pieces of information, for example one or more of the following: an installer identifier of the elevator system part, elevator system apparatus location, customer information, an identifier of a device that was used to order the elevator system part, an identifier of a device involved in installing the elevator system part, a date and a user responsible for the installation. For example, the following binds the signature to the identifier of the person who will be responsible for installing the part or spare part:

$$Signature = Sign ( elevator system apparatus identifer , part\_identifier , part\_serial , installer\_identifier , date )$$

$$Metadata = part\_identifier , part\_serial , installer\_identifier , date$$

The metadata can be used to ensure that the correct spare part is being delivered and installed. It can be used to enforce customer requirements, such as not allowing to replace a silver panel with a white one.

Further, to comply with the export regulations, elevator system apparatus may refuse the signature generated for another location.

In an example embodiment, if the online portal 818 and the elevator system apparatus share a password or a symmetric key, a hash-based message authentication (HMAC) or similar cryptographic construction may be used for generating the signature accompanying the part or spare part.

In an example embodiment, an elevator system apparatus manufacturer owning the keys used to generate the code and verifying it in the elevator system apparatus can use other parties such as OEMs (Original Equipment Manufacturer) for the manufacturing, warehousing, and parts deliveries. The party owning the keys can also outsource or license the whole or some parts of the process. In such a case, the signature generation may involve a front-end that relays signature generation requests to a backend. The elevator system apparatus manufacturer owning the keys can generate the signature in the backend and send the signature to the front-end that then delivers the signature the party which ordered the signature.

At 804, the signature used in the signature generation may be delivered to the elevator system apparatus from the online portal 818 via data communication. This communication may be protected, for example, with Transport Layer Security (TLS). In an example embodiment, the online portal 818 may also inform the elevator system apparatus about the expected delivery date of the part or spare part.

At 806A, the part or spare part is delivered. It may be accompanied by the metadata not sent over the network to the elevator system apparatus at so that the elevator system apparatus is able to verify the signature.

Alternatively, at 806B, if the metadata needed for signature verification at the elevator system apparatus is not sent along with the part or spare part, the metadata may be retrieved using a tool or service tool 822.

At 808, the user, maintenance personnel or technician 824 may provide the metadata to the elevator system apparatus so that the elevator system apparatus is able to verify the signature received from the online portal 818 earlier. In an example embodiment, the user, maintenance personnel or technician 824 may optionally put the elevator system apparatus into a maintenance mode before or after providing the metadata.

At 810, the elevator system apparatus may verify the signature using the corresponding public key (or symmetric key if HMACs are used). In an example embodiment, if the signature verification is successful, the elevator system apparatus may proceed to perform one or more additional checks. The additional check may include, for example, a check that the part_serial is correct for the elevator system apparatus and/or a check that the part_serial is not the one which was previously used. If all the additional checks are successful, the elevator system apparatus may reset any counter or timer tracking the usage of the old part. In an example embodiment, the elevator system apparatus may also check that the user, maintenance personnel or technician and/or the tool 822 being used is authorized for performing the installation of the part or spare part.

At 812, the elevator system apparatus may indicate a successful verification of the signature and all checks (if any checks were made) before the part or spare part installation begins. The indication may be, for example, a simple led light blinking green. In an example embodiment, the elevator system apparatus may also enter a special maintenance mode before the part can be installed.

At 814, the user, maintenance personnel or technician 824 may install the part or spare part.

One or more of the examples and example embodiments discussed above may enable a solution for preventing the use of non-genuine non-digital spare parts such ropes, dampers, brakes, or non-genuine digital spare parts.

Further, one or more of the examples and example embodiments discussed above may support different business models and works also with elevators or escalators maintained by third parties. Further, one or more of the examples and example embodiments discussed above may enable a solution that can be used to satisfy customer requirements and compliance with regulations such export controls. Further, one or more of the examples and example embodiments discussed above may enable a solution that is easy to integrate with existing controllers and spare parts ordering processes.

Further, one or more of the examples and example embodiments discussed above may enable a solution that works with elevators or escalators that do not have cloud connectivity. Further, one or more of the examples and example embodiments discussed above may enable a solution that does not require custom security chips but can use off-the shelf components available from multiple vendors to support supply chain operations.

The examples discussed above may be implemented in software, hardware, application logic or a combination of software, hardware and application logic. The example devices can store information relating to various methods described herein. This information can be stored in one or more memories, such as a hard disk, a solid state drive (SSD), an optical disk, a magneto-optical disk, an RAM, and the like. One or more databases can store the information used to implement the examples.

The databases can be organized using data structures (e.g., records, tables, arrays, fields, graphs, trees, lists, and the like) included in one or more memories or storage devices listed herein. The methods described with respect to the examples can include appropriate data structures for storing data collected and/or generated by the methods of the devices and subsystems of the examples in one or more databases.

The components of the examples may include computer readable medium or memories for holding instructions programmed according to the teachings and for holding data structures, tables, records, and/or other data described herein. In an example, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred examples thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure.

Moreover, it should be recognized that structures and/or elements and/or method steps shown and/or described in connection with any disclosed form or example may be incorporated in any other disclosed or described or suggested form as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator system apparatus, comprising:
at least one processor; and
at least one memory storing instructions that, when executed by the at least one processor, cause the elevator system apparatus to at least perform:
obtaining a signature associated with the elevator system apparatus, the signature having been generated based at least in part on an elevator system apparatus identifier and metadata at least in part associated with an elevator system part to be installed;
obtaining the metadata; and
verifying the signature using an encryption key, the elevator system apparatus identifier and the metadata.

2. The elevator system apparatus according to claim 1, the at least one memory storing instructions that, when executed by the at least one processor, cause the elevator system apparatus to at least perform:
outputting an indication about a successful verification in response to successfully verifying the signature.

3. The elevator system apparatus according to claim 1,
wherein the metadata comprises at least one of the following:
an identifier of the elevator system part;
a serial number of the elevator system part;
an installer identifier of the elevator system part;
elevator system apparatus location;
customer information;
an identifier of a device that was used to order the elevator system part;
an identifier of a device involved in installing the elevator system part; a date; and a user responsible for the installation.

4. The elevator system apparatus according to claim 1, the at least one memory storing instructions that, when executed by the at least one processor, cause the elevator system apparatus to at least perform:
in response to a successful verification, performing at least one check associated with the elevator system part; and
resetting a maintenance tracker associated with an existing elevator system part in response to performing the at least one check, the maintenance tracker tracking the usage of the existing elevator system part.

5. The elevator system apparatus according to claim 4, wherein the at least one check comprises:
checking that the part number of the elevator system part is correct for the elevator system apparatus; and/or
checking that a serial number of the elevator system part has not been used earlier.

6. The elevator system apparatus according to claim 1, wherein obtaining a signature associated with the elevator system apparatus comprises obtaining the signature from a network apparatus that generated the signature.

7. The elevator system apparatus according to claim 1, wherein obtaining a signature associated with the elevator system apparatus comprises obtaining the signature via a user input from a user.

8. The elevator system apparatus according to claim 1, wherein obtaining a signature associated with the elevator system apparatus comprises obtaining the signature from a user device via a wireless data transmission.

9. The elevator system apparatus according to claim 1, wherein obtaining the metadata comprises obtaining the metadata from a network apparatus that generated the signature.

10. The elevator system apparatus according to claim 1, wherein obtaining the metadata comprises obtaining the metadata from a user device via a wireless data transmission.

11. The elevator system apparatus according to claim 1, wherein obtaining the metadata comprises obtaining the metadata via a user input from a user.

12. The elevator system apparatus according to claim 1, wherein the elevator system part comprises a non-digital elevator system component.

13. The elevator system apparatus according to claim 1, wherein the elevator system part comprises a digital elevator system component.

14. A network apparatus, comprising:
at least one processor; and
at least one memory storing instructions that, when executed by the at least one processor, cause the network apparatus to at least perform:
obtaining an elevator system apparatus identifier and metadata at least in part associated with an elevator system part to be installed;
generating a signature associated with the elevator system apparatus based at least in part on the elevator system apparatus identifier and the metadata; and
providing the generated signature and the metadata.

15. The network apparatus according to claim 14, the at least one memory storing instructions that, when executed by the at least one processor, cause the network apparatus to at least perform:
receiving a request for the signature and the metadata; and
transmitting the signature and the metadata in response to the request.

16. The network apparatus according to claim 14, the at least one memory storing instructions that, when executed by the at least one processor, cause the network apparatus to at least perform:
transmitting the signature and the metadata to the elevator system apparatus.

17. The network apparatus according to claim 14, the at least one memory storing instructions that, when executed by the at least one processor, cause the network apparatus to at least perform:
receiving a request for the metadata; and
transmitting the metadata in response to the request.

18. The network apparatus according to claim 14, wherein the metadata comprises at least one of the following:
an identifier of the elevator system part;
a serial number of the elevator system part;
an installer identifier of the elevator system part;
elevator system apparatus location;
customer information;
an identifier of a device that was used to order the elevator system part;
an identifier of a device involved in installing the elevator system part;
a date; and
an identifier of a user responsible for the installation.

19. A method comprising:
obtaining, by an elevator system apparatus, a signature associated with the elevator system apparatus, the signature having been generated based at least in part on an elevator system apparatus identifier and metadata at least in part associated with an elevator system part to be installed;
obtaining, by the elevator system apparatus, the metadata; and
verifying, by the elevator system apparatus, the signature using an encryption key, the elevator system apparatus identifier and the metadata.

20. A method comprising:
obtaining, by a network apparatus, an elevator system apparatus identifier and metadata at least in part associated with an elevator system part to be installed;
generating, by the network apparatus, a signature associated with the elevator system apparatus, the signature having being generated based at least in part on the elevator system apparatus identifier and the metadata; and
providing, by the network apparatus, the generated signature and the metadata.

21. A non-transitory computer-readable medium storing a computer program comprising instructions which, when the program is executed by at least one processor, cause the least one processor to perform the method of claim 19.

22. A non-transitory computer-readable medium comprising a computer program comprising instructions which, when the program is executed by at least one processor, cause the at least one processor to perform the method of claim 20.
